(19) United States
(12) Patent Application Publication
(10) Pub. No.: US 2025/0283376 A1
(43) Pub. Date: Sep. 11, 2025

(54) SECURING DEVICE FOR HONEYCOMB BLINDS

(71) Applicant: CHING FENG HOME FASHIONS CO., LTD., Changhua County (TW)

(72) Inventors: WEN YING LIANG, Changhua County (TW); Sheng Ying HSU, Changhua County (TW); Chien Chih HUANG, Changhua County (TW); Wu Chung NIEN, Changhua County (TW); Ming Chu CHIANG, Changhua County, CA (US); Wei Ming SHIH, Changhua County, CA (US)

(21) Appl. No.: 18/766,465

(22) Filed: Jul. 8, 2024

(30) Foreign Application Priority Data
Mar. 7, 2024 (TW) 113108377

(51) Int. Cl. E06B 9/38; E06B 9/262

(52) U.S. Cl. CPC E06B 9/38; E06B 9/262; E06B 2009/2627

(57) ABSTRACT

A securing device for honeycomb blinds includes a frame component including two tabs symmetrically and resiliently extending from two facing insides of the frame component. Each tab includes a clamping piece for clamping a stack of slats, and a connecting piece formed between a middle of the clamping piece and one of the two facing insides of the frame component. A groove section is formed between the frame component and the two clamping pieces. When in use, the two tabs are pushed to protrude from the frame component, and the stack of slats is placed between the two tabs and the frame component. The frame component abuts against a bottommost slat of the stack of slats, while the topmost slat of the stack of slats is pressed by the tabs.

### FIELD OF THE INVENTION

The present invention relates to honeycomb blinds, and more particularly, to a securing device for honeycomb blinds.

### BACKGROUND OF THE INVENTION

The conventional honeycomb blinds consist of an upper beam, a lower beam, and honeycomb blinds placed between the upper and lower beams. Pulling down the lower beam causes the honeycomb blinds to expand, while pushing up the lower beam to position and fix the honeycomb blinds.

However, the drawbacks of the conventional honeycomb blinds are that, due to gravity, certain portions of the honeycomb blinds naturally expand. If subjected to wind, the swinging of the blinds increases the stress on the honeycomb blinds, thus accelerating the expansion and potentially causing damage due to pulling and tearing.

The applicant has previously proposed Taiwanese Utility Model Patent No. M241488 and U.S. Pat. No. 6,966,353B2, both of which are applicable to pleated blinds. However, pleated blinds are structured in a continuous zigzag shape, allowing for fixation on only one side of the blinds. The fixing structure of the aforementioned patents cannot be directly applied to honeycomb blinds. Additionally, honeycomb blinds have a more complex structure, requiring the design of a new fixing structure to address the issue of gravity-induced expansion.

The present invention intends to provide a device for securing honeycomb blinds to eliminate the drawbacks mentioned above.

### SUMMARY OF THE INVENTION

The present invention relates to a securing device for honeycomb blinds, and comprises a frame component including two tabs which symmetrically and resiliently extend from two facing insides of the frame component. Each tab includes a clamping piece for clamping a stack of slats, and a connecting piece formed between a middle of the clamping piece and one of the two facing insides of the frame component. A groove section is formed between the frame component and the two clamping pieces. When in use, the two tabs are pushed to protrude from the frame component so as to clamp the stack of slats between the two tabs and the frame component. The frame component abuts against a bottommost slat of the stack of slats, while the topmost slat of the stack of slats is pressed by the tabs.

Preferably, the frame component and the tabs are integrally formed.

Preferably, the groove section includes a gap formed between the two clamping pieces of the two tabs. The width of the gap is greater than the width of an adhesive portion of each slat of the stack of slats.

Preferably, the groove section is an I-shaped groove.

The primary object of the present invention is to provide a device for securing honeycomb blinds. The invention provides a frame component and two tabs that are resiliently deformable so as to secure the honeycomb blinds between the frame component and the tabs to prevent the honeycomb blinds from swinging due to wind and causing damage. Furthermore, the invention is easy to use and allows for quick fixation of the honeycomb blinds.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the use of the securing device of the present invention in the expansion of honeycomb blinds;

FIG. 2 is shows the use of the securing device of the present invention in the folding state of honeycomb blinds;

FIG. 3 is a perspective view to show securing device of the present invention;

FIG. 4 shows that the two tabs of the securing device of the present invention are pushed upward;

FIG. 5 shows the stack of slats is slid between the frame component and the two tabs of the securing device of the present invention;

FIG. 6 shows that the securing device of the present invention is located at the middle of stack of slats, and

FIG. 7 shows that two components of the present invention are used to secure the stack of slats.

### DETAILED DESCRIPTION OF THE PREFERRED EMBODIMENT

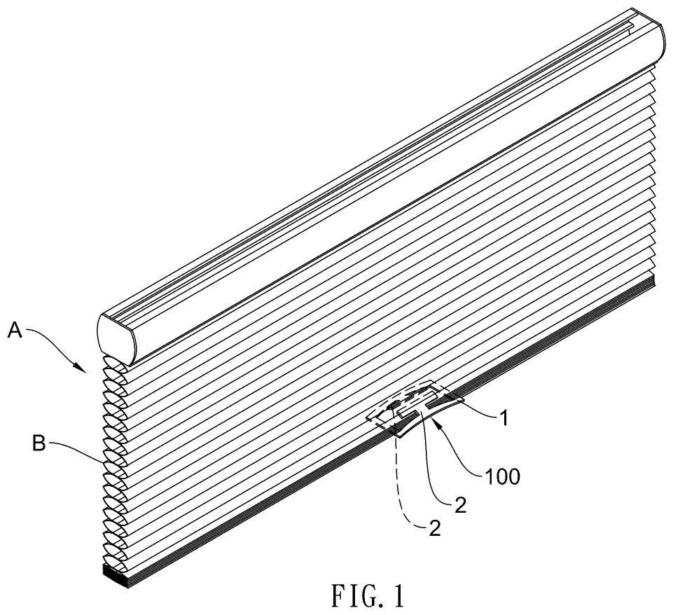

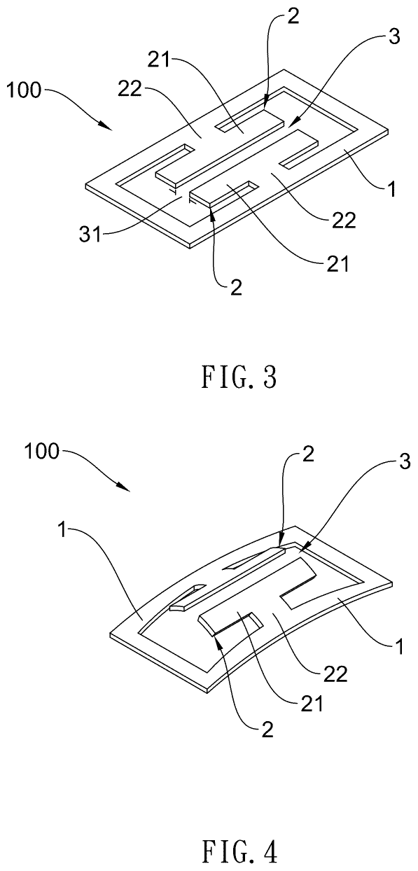

Referring to FIGS. 1 to 3, the securing device 100 for honeycomb blinds of the present invention is used to clamp a stack of slats “B” of a honeycomb blind “A” to prevent the slats “B” from drooping and swinging due to gravity. Each slat “B” of honeycomb blind “A” has an adhesive portion “B1”. The securing device 100 for honeycomb blinds of the present invention comprises a frame component 1 including two tabs 2 which symmetrically and resiliently extend from two facing insides of the frame component 1. Each tab 2 includes a clamping piece 21 for clamping the stack of slats “B”, and a connecting piece 22 formed between a middle of the clamping piece 21 and one of the two facing insides of the frame component 1. A groove section 3 is formed between the frame component 1 and the two clamping pieces 21. The groove section 3 is an I-shaped groove. Preferably, the frame component 1 and the tabs 2 are integrally formed.

The groove section 3 includes a gap 31 formed between the two clamping pieces 21 of the two tabs 2. The width of the gap 3 is greater than the width of the adhesive portion “B1” of each slat “B” of the honeycomb blind “A”.

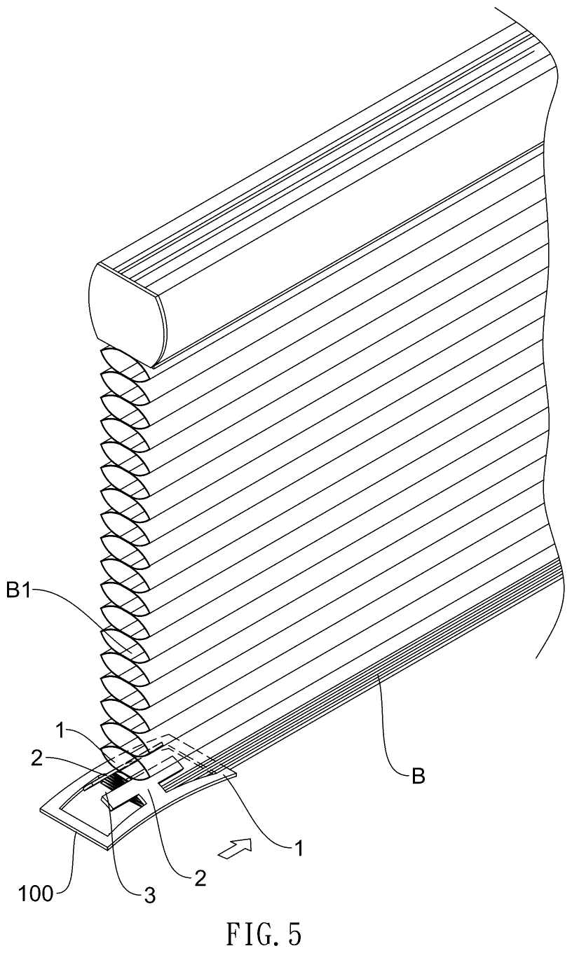

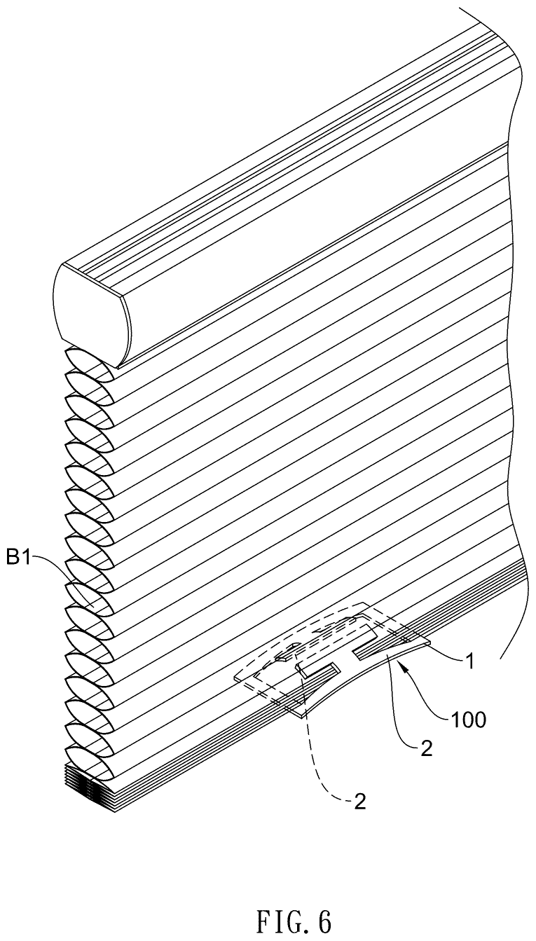

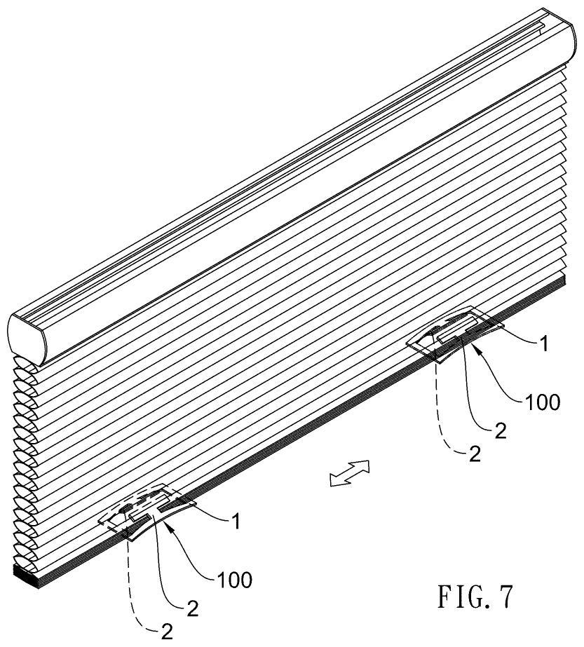

As shown in FIGS. 5 and 6, when in use, the two tabs 2 are pushed to protrude from the frame component 1 as shown in FIG. 4, and the stack of slats “B” is slid between the two tabs 2 and the frame component 1, such that the frame component 1 abuts against a bottommost slat “B” of the stack of slats “B”, while the topmost slat “B” of the stack of slats “B” is pressed by the tabs 2. Because the width of the gap 3 is greater than the width of the adhesive portion “B1” of each slat “B” of the honeycomb blind “A”, so that the stack of slats “B” can be easily slid beneath the two tabs 2.

The stack of slats “B” are then secured between the two tabs 2 and the frame component 1, and the present invention effectively prevents the slats “B” from drooping and swinging due to gravity.

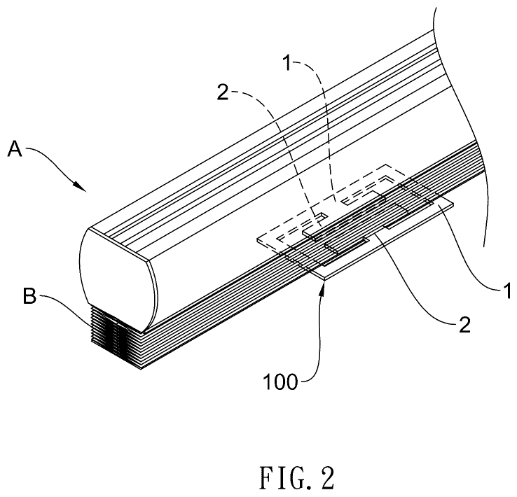

FIG. 1 illustrates the usage of the present invention in the expansion of honeycomb blinds, while FIG. 2 depicts the usage of the invention in the folded state of honeycomb blinds. In FIG. 1, the honeycomb blind “A” is well set its vertical length to prevent from rupture of the slats “B”. FIG. 2 shows that the honeycomb blind “A” is in a folded state, allowing the slats “B” to be tightly positioned and compressed.

As shown in FIG. 7, when the honeycomb blinds “A” is a larger one, it is possible to install two or more sets of the securing device 100 to the honeycomb blinds “A” to secure the slats “B”. This allows for a more uniform clamping effect on the honeycomb blinds “A”.

While we have shown and described the embodiment in accordance with the present invention, it should be clear to those skilled in the art that further embodiments may be made without departing from the scope of the present invention.

What is claimed is:

1. A securing device for honeycomb blinds, comprising:
a frame component including two tabs which symmetrically and resiliently extend from two facing insides of the frame component, each tab including a clamping piece for clamping a stack of slats and a connecting piece formed between a middle of the clamping piece and one of the two facing insides of the frame component, a groove section formed between the frame component and the two clamping pieces, when in use, the two tabs are pushed to protrude from the frame component so as to clamp the stack of slats between the two tabs and the frame component, the frame component is adapted to abut against a bottommost slat of the stack of slats, while the topmost slat of the stack of slats is pressed by the tabs.

2. The securing device for honeycomb blinds as claimed in claim 1, wherein the frame component and the tabs are integrally formed.

3. The securing device for honeycomb blinds as claimed in claim 1, wherein the groove section includes a gap formed between the two clamping pieces of the two tabs, a width of the gap is adapted to be greater than a width of an adhesive portion of each slat of the stack of slats.

4. The securing device for honeycomb blinds as claimed in claim 1, wherein the groove section is an I-shaped groove.
